(19) United States
(12) Patent Application Publication
(10) Pub. No.: US 2014/0362557 A1
(43) Pub. Date: Dec. 11, 2014

(54) LED White Light Source with a Combined Remote Photoluminescent Converter

(71) Applicant: ZAKRYTOE AKTSIONERNOE OBSCHESTVO "NAUCHNO- PROIZVODSTVENNAYA KOMMERCHESKAYA FIRMA "ELTAN LTD", Moskovskaya (RU)

(72) Inventors: Vladimir Nikolaevich Ulasyuk, Moskovskaya (RU); Vitaliy Nikolaevich Deynego, Moskva (RU); Naum Pinkhasovich Soschin, Moskovskaya obl. (RU)

(21) Appl. No.: 14/369,747

(22) PCT Filed: Dec. 19, 2012
(86) PCT No.: PCT/RU2012/001083

§ 371 Date: Jun. 30, 2014

(30) Foreign Application Priority Data
Dec. 30, 2011 (RU) 2011154397

(51) Int. Cl. F21K 99/00; F21V 9/16; F21V 7/20

(52) U.S. Cl. CPC F21K 9/56; F21K 9/54; F21V 7/20; F21V 9/16; F21Y 2101/02
USPC 362/84

(57) ABSTRACT

The invention relates to white-light sources based on semiconductor light-emitting diodes with remote photoluminescent converters. Essence of the invention: a lamp comprises a heat-dissipating base with a radiation exit opening, LEDs secured about the periphery of the opening and emitting a primary radiation, and, at a distance from said LEDS, a primary radiation converter in the form of a concave layer of photoluminescent material and a light reflector with a concave light-reflecting surface arranged consecutively on one side of the opening such that the concavities of the radiation converter and the light reflector are oriented towards the LEDs and the exit opening, wherein the lamp further comprises a second radiation converter which is situated on the other side of the opening and is flat or convex. Secondary radiation, generated as the primary radiation strikes the surface of the converter, exits via the opening in the heat-dissipating base and excites the photoluminescent material of the second radiation converter, causing the emission of tertiary radiation, and white light, generated as a result of the combination of the secondary and tertiary radiation, exits the second converter.

The present invention relates to electrical and electronic equipment, and more particularly to light sources based on semiconductor light-emitting diodes (LEDs), more particularly to a white light source based on LEDs with conversion photoluminescent phosphors.

Solid-state lighting technology is starting to conquer the white lighting market, thanks to recent advances in the development of efficient LEDs, especially nitride (InGaN), and the highest achievable lighting efficiency of all white light sources known in the art. LED solutions are widely used in the lighting apparatus, such as linear and street illuminators wherein the illuminator is relatively large, and intensely heated LEDs can be distributed so as to facilitate the efficient removal of heat from them. The development of LED replacements for standard incandescent and halogen lamps having a small form factor and a high luminous flux, in view of significant prospects for solving the energy saving problem, is one of the most critical scientific and technical tasks; however, its solution is significantly hindered by the limited space for installing the control electronics (drivers) and a relatively small surface area for removal of heat emitted by LEDs in such lamps. White LEDs often include a blue LED coated with YAG:Ce phosphor. High-power (one watt or more) blue LEDs have an efficiency of about 30-45%, with approximately 550-700 mW allocated to unit heating from each applied watt. Furthermore, it is believed that when phosphor converts the blue light into the yellow one in white LEDs, approximately 20% of the incident light energy is spent for phosphor heating. Technical specifications indicate that blue LED radiation power loss is about 7% at the temperature of 25-125° C., while power loss of white LEDs is about 20% at the same temperature. Thus, high-power white LEDs have substantial limitations on heat and luminous fluxes.

The objective of the present invention is to provide a LED lamp with a small form factor, wherein the problems of the known technical solutions have been overcome, to replace standard lamps.

The structure of any LED lamp designed to replace standard white light lamps is based on LED chips. White light results from mixing of radiation emitted from LED chips and different light colors such as blue, green and red, or blue and orange, etc.

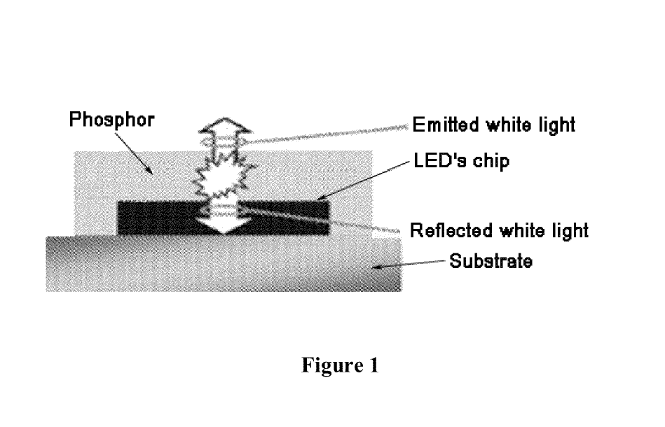

However, in recent years LED white light sources with photoluminescent phosphor converters, which radiate yellow or orange (red) light while absorbing blue or UV radiation of LED chip, are becoming the most widespread light sources. FIG. 1 shows a diagram explaining the operating principle of a white light source of this type.

The apparatus comprises a LED chip that emits primary relatively shortwave radiation and a conversion photoluminescent phosphor medium which is irradiated with the said relatively shortwave radiation and which, upon irradiation by the specified relatively shortwave radiation, is excited and emits in response a second radiation with relatively longer waves. In the particular embodiment, the monochrome blue or UV radiation emitting from the chip is converted to white light by placing the chip in organic and/or inorganic phosphors (photoluminescent phosphors) in a polymer matrix.

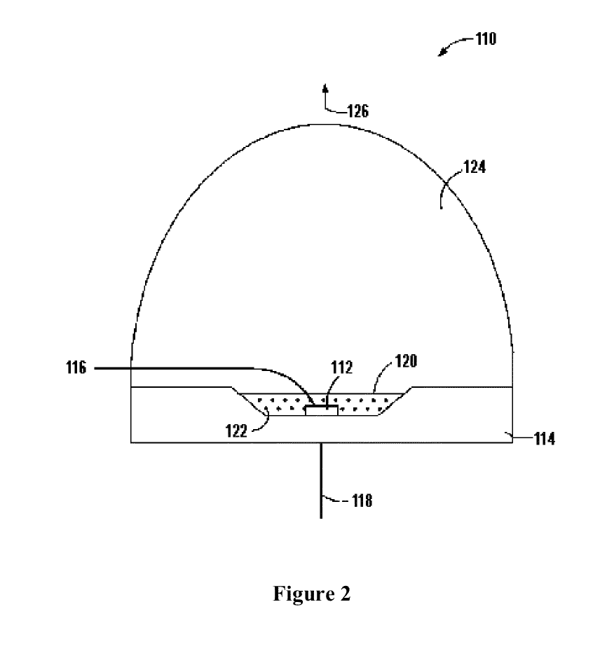

FIG. 2 shows a known LED white light source with photoluminescent phosphor conversion, as described in U.S. Pat. No. 6,351,069.

White light source 110 includes a nitride LED chip 112, which, when excited, emits primary blue radiation. The chip 112 is placed on the conductive frame of the reflector cup 114 and is electrically connected to conductors 116 and 118. Conductors 116 and 118 supply the chip 112 with electric power. The chip 112 is covered with the transparent resin layer 120 that includes conversion material for converting the wavelength of radiation 122. Conversion material type used to form layer 120 can be selected depending on the desired spectral distribution of the secondary radiation produced by material 122. The chip 112 and the fluorescent layer 120 are covered by a lens 124. The lens 124 is typically made of a transparent epoxy or silicone. When using a white light source the voltage is applied to the chip 112, wherein the primary radiation is emitted by the upper surface of the chip. The emitted primary radiation is partially absorbed by the conversion material 122 in the layer 120. Thereafter the conversion material 122, in response to the absorption of the primary light, emits secondary radiation, i.e. converted light having a peak with a longer wavelength. The remaining unabsorbed portion of the emitted primary radiation is transmitted through the conversion layer together with the secondary radiation. The lens 124 directs the unabsorbed primary radiation and the secondary radiation in a general direction indicated by the arrow 126 as outgoing light. Thus, the outgoing light is a complex light which is composed of the primary radiation emitted by the chip 112 and the secondary radiation emitted by the conversion layer 120. The conversion material can also be configured so only a small portion or even all primary light remains in the device as in the case of a chip that emits primary UV light combined with one or more conversion materials emitting visible secondary light.

The aforementioned apparatus known in the art, wherein a photoluminescent phosphor layer is formed on LED surface, has several disadvantages. It is difficult to achieve color uniformity when photoluminescent phosphor is in direct mechanical, optical and thermal contact with the LED surface due to significant changes in the light path length depending on the angle of radiation propagation through the photoluminescent phosphor layer. Furthermore, high temperature of the heated LED can undesirably alter the color coordinates of the photoluminescent phosphor or can lead to its degradation.

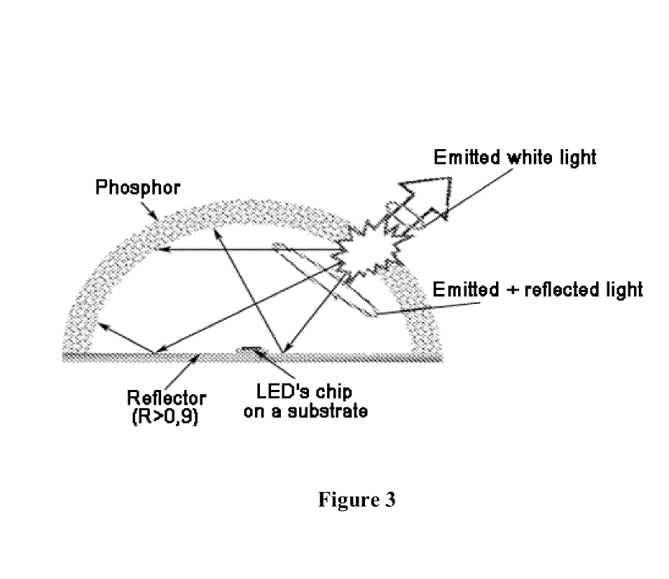

In order to eliminate the specified disadvantages we propose white light sources with a wavelength converter remote from LED, which operating principle is explained in FIG. 3.

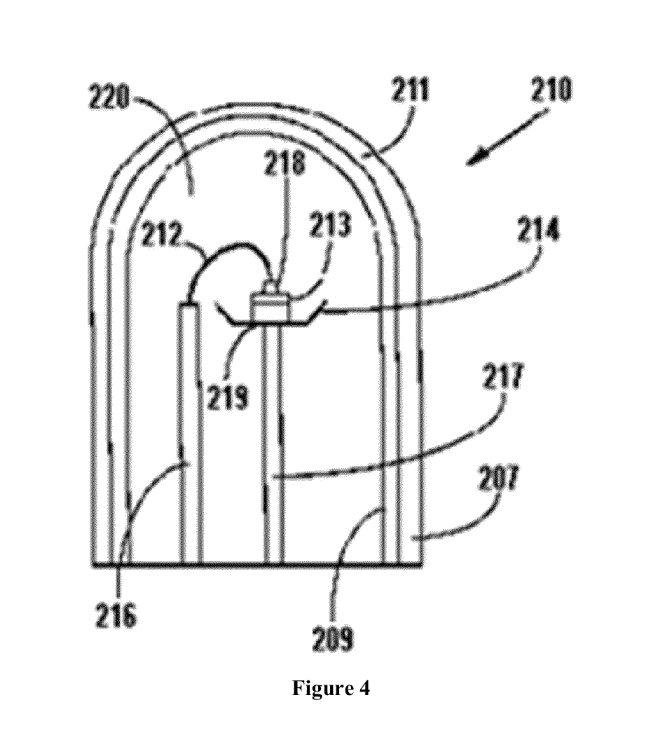

The arrangement of the illuminator built according to this principle and described, for instance, in U.S. Pat. No. 6,600,175 (B1) is shown in FIG. 4.

This white light source comprises a shell 207 formed by a transparent medium 211, with an internal volume. The medium 211 can be formed by any suitable material that transmits light, such as transparent polymer or glass. The internal volume of the medium 211 comprises a light emitting diode (LED) 213 chip placed on the base 214. First and second electrical contacts 216 and 217 are connected to radiating and back sides 218 and 219 of the LED 213 chip, respectively, and to a radiating side 218 of the LED, which is next to the first electrical contact 216 by the conductor 212. The light transmitting medium 211 is associated with fluorescent and/or phosphorescent components, or mixtures thereof, in other words, photoluminescent phosphor medium which converts the radiation emitted by the side 218 of the LED 213 into white light.

Photoluminescent phosphor is scattered in the shell 207 of the medium 211 and/or is arranged in the form of a film coating 209 on the inner wall of the shell 207 surface. Alternatively, photoluminescent phosphor can be a coating on the outer wall of the assembly (not shown) shell if the shell is used exclusively in the environment, wherein such an outer coating can be satisfactorily maintained (e.g., where it is not subject to abrasion or degradation). For example, photoluminescent phosphor can be distributed in polymer, or glass melt, from which the shell is formed to provide a homogeneous composition of the shell and ensure light output from the entire surface of the shell.

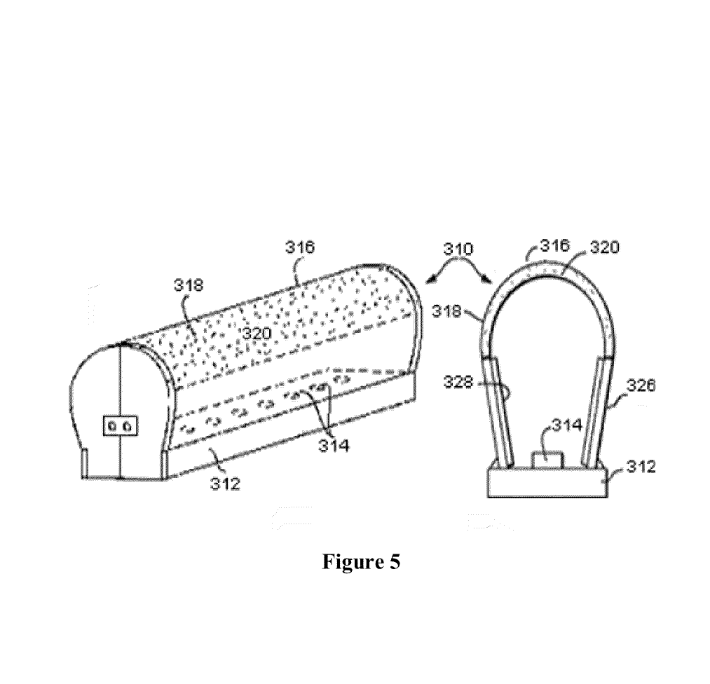

Elongated white LED illuminator with remote cylindrical converter is known in the art, as described in U.S. Pat. No. 7,618,157 B1. Its arrangement is schematically shown in FIG. 5. The illuminator 310 comprises a linear heat sink 312, a plurality of the LEDs 314 mounted on the heat sink 312 along the long side of the heat sink, and the light emitting dome 316 mounted on the heat sink 312 on one line with the LEDs 314, wherein a portion 318, half-round in section, of the dome 316 located against the LEDs 314 comprises a photoluminescent phosphor 320 which is excited by the light from the LEDs. The heat sink 312 is made of heat-conductive material, such as aluminum. The dome 316 is made of transparent material, such as glass or plastic. The photoluminescent phosphor 320 can be applied as a coating on the inner side of the dome or introduced into the coating material. The flat portions 326 without photoluminescent phosphor which are attached to the heat sink on both sides of the LEDs have internal reflective surfaces 328, for example, aluminum coatings reflecting light which comes from the LEDs 314 to the dome portion 318.

The conversion layer can comprise photoluminescent phosphor material, quantum dot material, or a combination of such materials, and can further comprise a transparent host material, wherein phosphor material and/or quantum dot material are dispersed.

It is known that the layers that contain powdered photoluminescent phosphor materials can conduct, absorb, reflect and dissipate the light incident on them. When this layer dissipates the light, it can also conduct, absorb and reflect some of the scattered light.

Due to this fact a common disadvantage of said known inventions is that the radiation excited in photoluminescent phosphor grains under the influence of LED radiation as well as reflected LED radiation are inevitably partially absorbed in the photoluminescent phosphor layer and on inner elements of the apparatus, which reduces efficiency of the white light source.

Yamada [1] and Narendran [2] determined the ratio of portions of the radiation propagating back and forth from the conversion layer of the photoluminescent phosphor YAG:Ce excited by blue light radiation with a wavelength of about 470 nm, which is converted into yellow wavelength range radiation. Narendran proved that in this case more than 60% of the light emitted and reflected by the conversion layer extends back to the excitation source, and a large portion of this light is lost within the LED assembly [2]. In [3] it is proved that even in the case of YAG:Ce photoluminescent phosphor with optical refractive index 1.8, which is mixed in epoxy resin with optical refractive index 1.6 at the photoluminescent phosphor density of 8 mg/cm2, which allows creating a balanced white light portions of back-directed and passed forth radiation, including blue and yellow light radiation, are 53% and 47%, respectively, while for the yellow light only such portions are 55% and 45%, respectively.

Therefore, a significant gain in light flux and maximum possible efficiency of LED conversion white light sources can be achieved in all conditions being equal, by directing the radiation coming from the photoluminescent phosphor surface immediately irradiated by LED radiation to the exit aperture of the LED light source to a remote converter.

Similar technical solution is proposed in U.S. Pat. No. 7,293,908 B2 in which one of the claimed embodiments of the lighting system with side light radiation coupling, which is completed according to this patent, includes a conversion layer which is remote from the LED and located on the light reflector.

This apparatus is most similar to the apparatus according to the present invention and, therefore, chosen as the prototype.

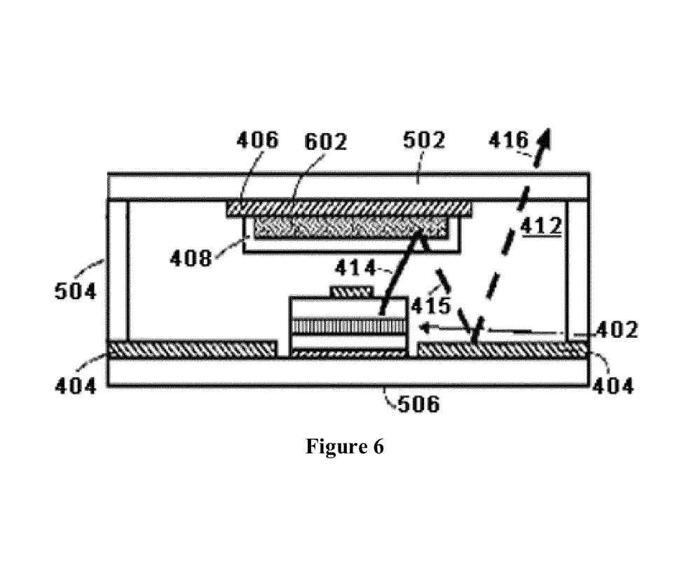

The operating principle of the white light source with side light radiation coupling implemented in accordance with the present patent is explained in FIG. 6, which shows a cross-section of one of the claimed embodiments of the lighting system with side light radiation coupling.

The lighting system with side light radiation coupling comprises a LED 402, the first reflector 404, the second reflector 406, an exit aperture 412, a conversion layer 602, an additional transparent covering layer 408, and supporting means which support and separate the second reflector 406 from the first reflector 404. The supporting means include a flat transparent element 502, side supports 504 and a base 506. The side supports 504 are, preferably, transparent or reflective. The first reflector 404 is attached to the base 506. The second reflector 406 is attached to the flat transparent element 502. The conversion layer 602 is located on the second reflector 406 surface and converts at least a portion of the primary radiation emitted by the active area of the LED 402 into radiation with the wavelength different from the primary radiation wavelength.

For the illustrative purposes let us consider light beams 414, 415 and 416 which explain the operation of the lighting system with side light radiation coupling. The light beam 414 of the first color is emitted by the LED 402 active area and directed to the LED 402 output surface. The light beam 414 of the first color passes through the LED 402 output surface and is directed to a transparent covering layer 408. The light beam 414 of the first color passes through the transparent covering layer 408 and is directed to the conversion layer 602 which converts the light beam 414 of the first color in the light beam 415 of the second color different from the first color. Light of the second color can be emitted in any direction from the point of wavelength conversion. The beam 415 of the second color is directed through the transparent covering layer 408 and, then, directed through the exit aperture 412 to the first reflector 404. The light beam 416 of the second color is reflected by the first reflector 404 and directed to the flat transparent element 502. The light beam 416 of the second color passes through the flat transparent element 502 and comes out the lighting system with side light radiation coupling.

The disadvantage of this system is large aperture losses and loss of light at the boundaries of the supporting means and on the reflectors.

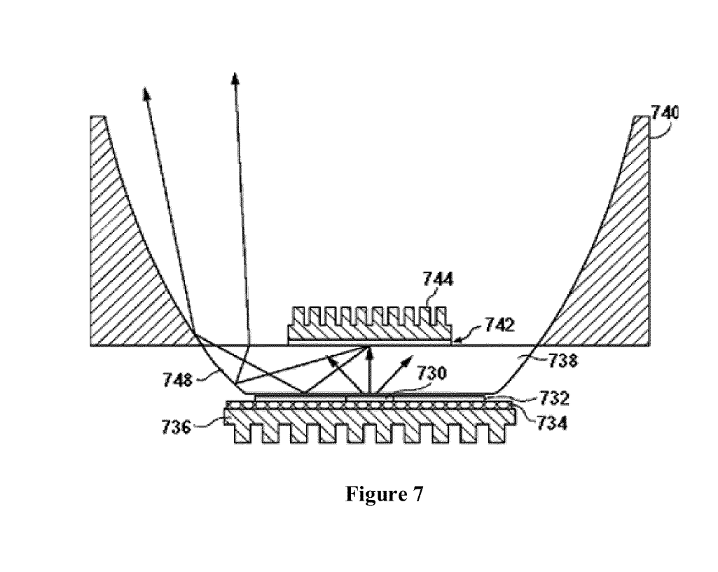

An attempt to overcome these disadvantages was made in another known white light source of searchlight type described in U.S. Pat. No. 7,810,956 B2. FIG. 7 illustrating the arrangement and the operating principle of such apparatus, is a cross-section view of a searchlight lamp according to one of the embodiments of the invention claimed in the U.S. Pat. No. 7,810,956 B2. The light source 730 is placed on a fastener 734 and an additional thermal heat sink 736. The thermal heat sink 736 can be finned, as shown in FIG. 7. The light emitted by the source 730 and reflected from the mirror 732 surrounding the light source 730 is radiated in an optical plate 738. The wavelength conversion layer 742 is separated from the light source 730 and placed so the light from the source 730 can be received. The additional thermal heat sink 744 can cool the conversion layer 742. The collecting optics 740 collimates the light. As the light source 730, a LED which generates shortwave light, e.g. blue or ultraviolet light, can be used. The light source 730 can be placed on the additional fastener 734 and attached to the additional thermal heat sink 736. The optical plate 738 can be formed so that it directs light to the collecting optics 740. For example, the sides 748 can be inclined or bent so that the total internal reflection directs light to the collecting optics 740.

The disadvantage of this system is large aperture losses and loss of light at the boundaries of the optical plate with the light source, mirrors, and the conversion layer, which eliminate its efficiency. Furthermore, the light beam outgoing from the collimating optical system is rather thin, which is not acceptable when using this illuminator as a replacement for standard lamps with small form factor, which have sufficient angular aperture of emitted light beam, even if the halogen lamps are used.

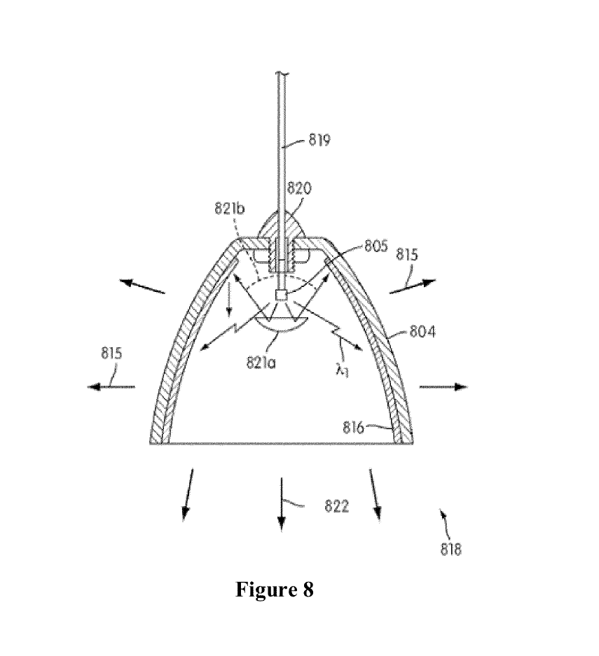

FIG. 8 shows another known white light source wherein radiation is emitted by the surface of a remote photoluminescent converter directly irradiated by the LED described in the U.S. Pat. No. 7,972,030 B2 patent. This device is the closest counterpart of the one provided herein and is therefore selected as the prototype. The working principle of the white light source fabricated in accordance with abovementioned patent is illustrated by FIG. 8 showing a sectional view of one of the claimed light sources. The light source (818) has a lampshade (804) made from a transparent material and at least one LED (805) installed inside said lampshade (804). The phosphor layer (816) is provided on the inner surface of said lampshade (804). The LED (805) is powered via the cable 819 passing through the cable feedthrough fastener 820. The light source may have a parabolic reflector directing the radiation λ₁ emitted by the LED (805) to the lampshade (804) in one of two reflector location embodiments (821a, 821b). For the first embodiment the reflector 821a is installed below the LED 805 and reflects the radiation emitted by the LED 805 to the lampshade 804 to avoid direct emission of LED 805 radiation to the user's eyes. The advantage of this design is guaranteed homogeneous color of the light 822 produced by the source 818. For the second embodiment 821b the reflector shown by dashes is installed above the LED 805 and reflects the radiation incident upon it from the open side of the light source 818. The blue radiation λ₁ emitted by the LED (805) in combination with the yellow radiation emitted by the phosphor (816) form the light (822) produced by the source which appears white.

Disadvantages of said light source is relatively high light loss at the reflector (aperture loss due to radiation interception by the reflector body and its absorption in the reflector surface material) and poor heat removal from the LED reducing light source performance.

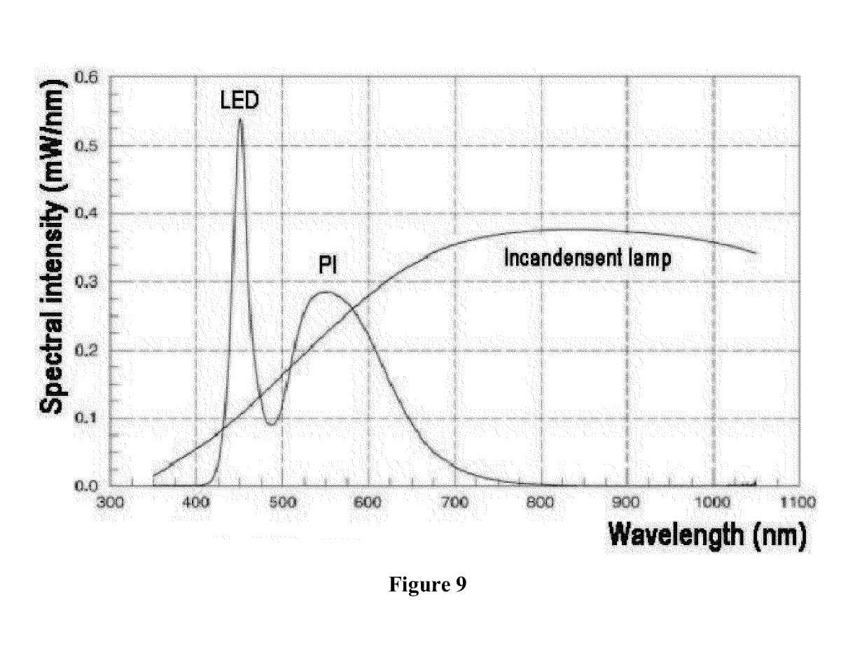

A common significant disadvantage of all existing LED white light sources is the human hazardous effect of the intense 450-470 nm blue radiation of LED light sources that directly irradiates human eyes by virtue of their working principle in accordance with which blue LED radiation with a relatively high intensity and a wavelength in that range (450-470 nm) forms the white radiation spectrum of the LED light source by mixing, e.g., with the yellow radiation produced by the phosphor excited by the LED. This is illustrated in FIG. 9 showing the radiation spectrum of a typical blue nitride LED coated with the most widely used YAG:Ce phosphor vs the spectrum of an incandescent lamp which is in fact accepted as a reference of harmlessness for human body.

The fast spreading of LED light sources raises interest to the medical and biological aspects of their use, primarily to the effect of the “new” light on the psychological and physiological condition, and to possible delayed LED radiation effects. The urgency of this problem is caused by the fact that the radiation spectrum of the most widespread phosphor-coated white LEDs differs noticeably from that of other type lamps by the presence of a strong band in the 450-470 nm range.

Recent international LED radiation research showed the effect of direct LED radiation on the biological clock and hormone system of humans. This effect is caused by the strong blue component in the LED spectrum. Heating of the LED and aging of the phosphor layer lead to an increase in the percentage of blue in the LED white spectrum. The blue spectrum component affects the circadian rhythm of humans through eye pigments (melanopsin) and the hormone system.

It is currently believed that the human eye has two radiation perception channels:
the optical one the sensors of which are the well-known 3 types of cones (color daytime vision) and rods (grey twilight vision);
recently discovered [4] non-optical, or biological, channel based on melanopsin containing ganglion cells which controls the secretion of melatonin in blood thereby determining active and relaxed conditions. Incorrect illumination and hence violation of the biochemical blood composition may damage sleeping and psychological condition and, in case of long-time exposure, even favor the development of breast cancer.

It is therefore extremely important to control light spectrum and its components if people are for a long time exposed to artificial light. This indicates that the currently popularized concept of light source fabrication on the basis of LEDs does not ensure safety for human eyes and general health. For example, an international team of researchers from the Haifa University, Israel, the National Geophysical Data Center, US, and Light Pollution Research Institute, Italy, showed [5] that LED light lamps are most hazardous for health because they reduce the production of melatonin that controls the biological clock and has antineoplastic and immune stimulation effects. Yellow sodium lamps also have this effect but it is five times lower and do not affect human health to such an extent.

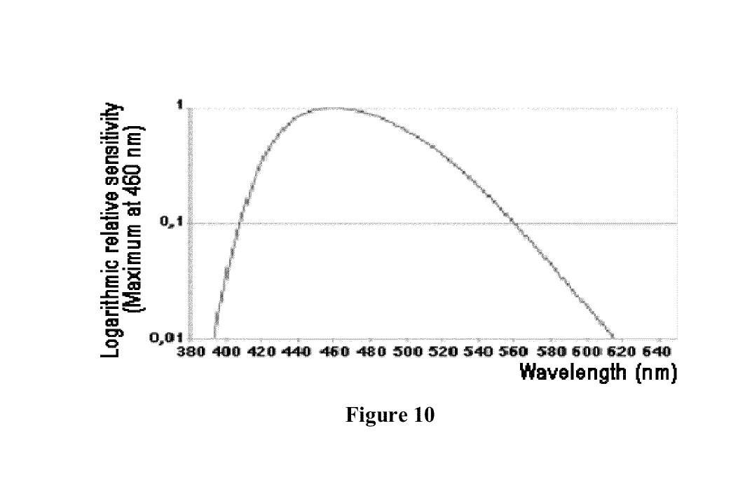

Melatonin controls the biological clock of humans, has a positive effect on the immune system and therefore prevents tumor development. It has long been known that blue light suppresses the production of melatonin (e.g. FIG. 10 shows melatonin production as a function of light spectral composition obtained in 2004 [16]) but the abovementioned study for the first time showed the quantitative parameters of the effect of different electric lamp types on human body. As a reference, the researchers accepted the melatonin production level for high pressure sodium yellow lamps. Compared with these lamps, LED ones suppress melatonin production by more than five times (per unit power).

The growing use of LED light sources for city, office and apartment illumination causing increased people's exposure to artificial illumination has lead to modifications to the Hygienic Requirements to Natural, Artificial and Combined Illumination of Apartment and Public Buildings (SanPiN 2.2.1/2.1.1.1278-03). The new rules (SanPiN 2.2.1/2.1.1.2585-10) do not contain the provision limiting the allowed light sources to two types, i.e. incandescent and discharge lamps. Instead the new rules limit the allowed range of color temperatures, i.e. from 2400 to 6800 K. The rules introduce the requirement to LED light sources to contain a protecting edge (no specific figures are, however, given). Use of LED light sources in pre-school institutions, schools and vocational schools as well as in most medical institutions is forbidden. The new rules allow reducing the illumination level by one degree if light sources with a color rendition of above 90 are used.

Therefore the task of reducing the harmful effect of LED illumination on people is becoming increasingly important.

The main object of this invention is reducing or eliminating the harmful effect of remote converter LED white light sources, providing maximum efficiency and achieving high color homogeneity and color rendition with small form factor light sources.

We provide a light source comprising a near ultraviolet or violet primary radiation source comprising of one or multiple LEDs, a heat removing base on which said LEDs are installed, a reflector with a reflecting surface arranged face to the LED, a first conversion layer for converting the primary radiation into secondary blue/light-blue or blue/green radiation, located between said LED and said reflector, and a second conversion layer for converting the secondary radiation into ternary yellow, yellow/orange or red radiation located at a distance from said first conversion layer at the said of said first conversion layer. The object specified herein is achieved by providing a radiation removing aperture in said heat removing base, wherein said LED and said first conversion layer are located on said heat removing base in the vicinity of said aperture, further wherein said first conversion layer surface irradiated by said LED and the surface of said reflector have concave shapes with said concave surface facing said primary radiation source and said aperture and said second conversion layer has a planar or convex shape and is located in said aperture or at the other side of said aperture, the LED emission spectrum is in the excitation spectral region of said first conversion layer material, preferably, within the spectral range equal to the halfwidth of the first conversion layer material excitation spectrum at both sides of the first conversion layer material excitation spectral maximum, and the maximum of the emission spectrum of the photoluminescent material of the first conversion layer is in the excitation spectral region of the photoluminescent material of the second conversion layer, preferably, within the spectral range equal to the halfwidth of the second conversion layer material excitation spectrum at both sides of the second conversion layer material excitation spectral maximum. This mutual location of the light source elements excitation and emission spectra participating in the production of white light provides for a high efficiency of the light source. The first conversion layer excitation spectrum maximum is within the 450-470 nm range thus suppressing the harmful blue component in the 450-470 nm range of the second conversion layer emission spectrum and hence in the white light produced by the source without impairing the white light color rendition due to the presence of the blue/light-blue component in the range 470+ nm in the second conversion layer emission spectrum which is expressed but slightly e.g. in the emission of the most widespread white LEDs in which LED chips with 450-470 nm emission wavelength are coated with yellow phosphor YAG:Ce (FIG. 9).

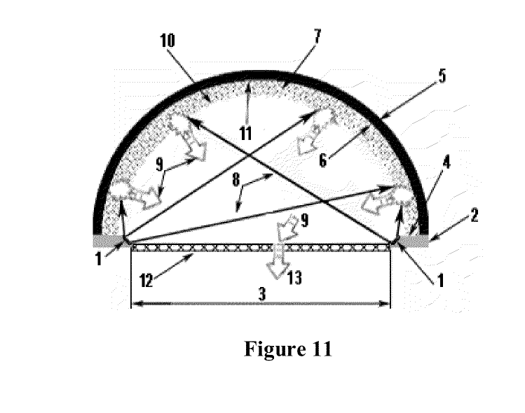

The disclosure of the invention is explained in FIG. 11, which schematically shows cross-section of the proposed illuminator.

The light source comprises a primary radiation source comprising one or multiple LEDs 1 emitting in the ultraviolet or violet spectral region, a heat removing base 2 with an aperture 3 and a surface 4 on which said LED 1 are installed, a reflector 5 with its concave reflecting surface 6 facing the LED, a first conversion layer 7 for converting primary radiation 8 into secondary blue/light-blue or blue/green radiation 9, with a concave surface 10 facing said LED 1 and a second convex surface 11 facing said reflecting surface 6, wherein said first conversion layer 7 is located between LED 2 and said reflecting surface 6, a second conversion layer 12 located in said aperture 3 for converting secondary radiation 9 into tertiary yellow, yellow/orange or yellow/red radiation 13.

The illuminator functions as follows: The primary radiation 8 of the LED 1 reaches the surface 10 of the conversion layer 7, then reflects partially from the surface 10, exiting through the aperture 3 of the heat-removing base 2, reflects partially from the surfaces of photoluminescent phosphor grains, being dissipated in the conversion layer 7, is absorbed partially by the conversion layer 7 material transforming into secondary radiation 9; concurrently, a portion of the primary radiation 8 which has reached the light-reflective surface 6, reflects back into the conversion layer 7 and is again partially absorbed by the material of the conversion layer 7 with the conversion into secondary radiation 9 by the photoluminescent phosphor of the conversion layer 7. Secondary radiation 9 is emitted from the conversion layer to the aperture 3 of the light source and partially absorbed by the material of the second conversion layer 12 being converted into tertiary radiation 13 which mixes with secondary radiation 9 to form white radiation the spectral distribution of which depends on the materials of the conversion layers, primarily, the composition and size of phosphor particles and the thicknesses of the conversion layers. Part of the primary radiation of LED 1 coming to the aperture 3 is absorbed in the second conversion layer 12.

The choice of phosphor composition is of great importance because the device is based on cascade conversion of LED radiation and comprises at least two phosphors.

Photoluminescent phosphors are usually optical inorganic materials doped with ions of rare earth elements (lanthanides), or, alternatively, ions of the elements, such as chromium, titanium, vanadium, cobalt or neodymium. Lanthanide elements are lanthanum, cerium, praseodymium, neodymium, promethium, samarium, europium, gadolinium, terbium, dysprosium, holmium, erbium, thulium, ytterbium and lutetium. Optical inorganic materials include (but are not limited to): sapphire (Al₂O₃), gallium arsenide (GaAs), beryllium aluminum oxide (BeAl₂O₄), magnesium fluoride (MgF₂), indium phosphide (InP), gallium phosphide (GaP), yttrium aluminum garnet (YAG or Y₃A₁₅O₁₂), terbium-containing garnet, yttrium-aluminum-lanthanide oxide compounds, compounds of yttrium, a lanthanide-aluminum-gallium oxides, yttrium oxide (Y₂O₃), calcium or strontium or barium halophosphates (Ca,Sr,Ba)₅(PO₄)₃(Cl,F), the composition CeMgAl₁₁O₁₉, lanthanum phosphate (LaPO₄), lanthanide pentaborate materials ((lanthanide) (Mg, Zn) B₅O₁₀), the composition BaMgAl₁₀O₁₇, the composition SrGa₂S₄, compounds (Sr,Mg,Ca,Ba)(Ga,Al,In)₂S₄, the composition SrS, the composition ZnS and nitride silicates.

There are several typical photoluminescent phosphors which can be excited by UV radiation with a wavelength of 250 nm or close to this. A typical red-emitting photoluminescent phosphor is Y₂O₃:Eu⁺³. A typical yellow-emitting photoluminescent phosphor is YAG:Ce⁺³. Typical green-emitting photoluminescent phosphors include: CeMgAl₁₁O₁₀:Tb<3+>, (lanthanide) PO₄:Ce⁺³,Tb⁺³ and GdMgB₅O₁₀:Ce⁺³,Tb⁺³. Typical blue-emitting photoluminescent phosphors are BaMgAl₁₀O₁₇:Eu⁺² and (Sr,Ba,Ca)₅(PO₄)₃Cl:Eu⁺². For a LED of excitation with a longer wave with the wavelength range of 400-450 nm or close to it, the typical optical inorganic materials include yttrium aluminum garnet (YAG or Y₃Al₅O₁₂), terbium-containing garnet, yttrium oxide (Y₂O₃), YVO₄, SrGa₂S₄, (Sr,Mg,Ca,Ba)(Ga,Al,In)₂S₄, SrS, and nitride silicates. Typical photoluminescent phosphors for LED of excitation in the wavelength range of 400-450 nm include YAG:Ce⁺³, YAG:Ho⁺³, YAG:Pr⁺³, SrGa₂S₄:Eu⁺², SrGa₂S₄:Ce⁺³, SrS:Eu⁺² and nitride silicates doped with Eu⁺².

Furthermore, blue light emitting phosphors can be selected from a group comprising (Sr₁₋ₓ₋ₐBaJ₃MgSi₂O₈:Euₐ (a=0.002-0.2, x-0.0-1.0); (Sr₁₋ₓ₋ₐSr)₂P₂O₇:Euₐ (a=0.002-0.2, x=0.0-1.0); (Sr₁₋ₓ₋ₐBaₓ)Al₁₄O₂₅:Euₐ (a=0.002-0.2, x=0.0-1.0); La₁₋ₐSi₃N₅:Ceₐ (a=0.002-0.5); (Y₁₋ₐ)₂SiO₅:Ceₐ (a=0.002-0.5); (Ba₁₋ₓ₋ₐSrₓ)MgAl₁₀O₁₇:Euₐ (a=0.01-0.5, x-0.0-0.5).

This invention uses a new blue light emitting phosphor with the general formula (Mg,Ca,Sr)₂(PO₄)Cl:Eu⁺², wherein Eu⁺² concentration is from 0.5% to 10% and the components are in the following ratios: (Mg: 0.05-0.2; Ca: 0.6-0.8; Sr: 0.01-0.2). Changing these ratios one can vary the maximum position and halfwidth of the emission spectrum over a wide range. Furthermore, this invention can use the following specially synthesized new efficient blue light emitting phosphors:
LiCaPO₄:Eu with the emission spectrum maximum at 450 nm and a halfwidth of 72 nm;
NaCaPO₄:Eu with the emission spectrum maximum at 460 nm and a halfwidth of 75 nm;
KCaPO₄:Eu with the emission spectrum maximum at 468 nm and a halfwidth of 80 nm.

Typical optical inorganic materials for longer wave LED excitation in the 400-470 nm range or nearby include alumo-yttrium garnet (YAG or Y₃Al₅O₁₂), terbium containing garnet, yttrium oxide (Y₂O₃), YVO₄, SrGa₂S₄, (Sr,Mg,Ca,Ba)(Ga,Al,In)₂S₄, SrS, and nitridosilicates. Typical phosphors for LED excitation in the 400-450 nm range include YAG:Ce³⁺, YAG:Ho³⁺, YAG:Pr³⁺, SrGa₂S₄:Eu²⁺, SrGa₂S₄:Ce³⁺, SrS:Eu²⁺ and Eu²⁺ doped nitridosilicates; (Lu_{1-x-y-a-b}YₓGd_{y})₃ (Al_{1-z}Ga_{z})₅O₁₂:Ceₐ³⁺ Pr_{b}³⁺, where 0<x<1, 0<y<1, 0<z<=0.1, 0<a<=0.2Ø0<b<=0.1 including, for example, Lu₃Al₅O₁₂:Ce³⁺ and Y₃Al₅O₁₂:Ce³⁺; (Sr_{1-a-b}Ca_{b}Ba_{c})SiₓN_{y}O_{z}:Euₐ²⁺ (a=0.002-0.2, b=0.0-0.25, c=0.0-0.25, x=1.5-2.5, y=1.5-2.5, z=1.5-2.5), including, for example, SrSi₂N₂O₂:Eu²⁺; (Sr₁₋ᵤ₋ᵥ₋ₓMgᵤCaᵥBaₓ)(Ga_{2-y-z}Al_{y}In_{z}S₄):Eu²⁺, including, for example, SrGa₂S₄:Eu²⁺ØSr₁₋ₓ,BaₓSiO₄:Eu²⁺.

The red light emitting phosphor can be selected from a well-known group comprising (Sr_{1-a-b-c} Ba_{b}Ca_{c})₂Si₅N₈:Euₐ (a=0.002-0.2, b=0.0-1.0, c=0.0-1.0); (Ca₁₋ₓ₋ₐSrₓ)S:Euₐ, (a=0.0005-0.01, x=0.0-1.0); Ca₁₋ₐSiN₂:Euₐ (a=0.002-0.2); Ø(Ba₁₋ₓ₋ₐCaₓ) Si₇N₁₀:Euₐ (a=0.002-0.2, x=0.0-0.25); (Ca₁₋ₓSrₓ)S:Eu²⁺, where 0<x<=1, e.g., CaS:Eu²⁺ØSrS:Eu²⁺; (Sr_{1-x-y}BaₓCa_{y})_{2-z}Si₅₋ₐAlₐN₈₋ₐOₐ:Eu_{z}²⁺ where 0<=a<5, 0<x<=1, 0<=y<=1Ø0<Z<=1, e.g., Sr₂Si₅N₈:Eu²⁺.

This invention uses a specially synthesized new red light emitting phosphor with the general formula (Ba,Ca,Zn,Eu)₂S₄ wherein the components are in the following ratios: (Ba: 0.9-1.4; Ca: 0.9-0.4; Zn: 0.05-0.15; Eu 0.02-0.05). Changing these ratios one can vary the maximum position and halfwidth of the emission spectrum over a wide range.

As photoluminescent phosphores can be used quantum-dot materials—inorganic semiconductor fine particles of less than about 30 nm. Typical quantum-dot materials include (but are not limited to) particles of CdS, CdSe, ZnSe, InAs, GaAs and GaN. Quantum-dot materials can absorb light of one wavelength and then re-emit the light with different wavelengths, which depend on the particle size, particle surface properties, and the inorganic semiconductor material.

The conversion layer can include both one type of photoluminescent phosphor material or quantum-dot material and a mixture of photoluminescent phosphor materials and quantum-dot materials. Using a mixture of more than one of such material is appropriate if it is desirable to have a wide spectral range of the emitted white light (high color rendering). One of the typical approaches to obtain warm white light with high color rendering index is mixing radiation of InGaN LED with the radiation of the mixture of yellow and red conversion photoluminescent phosphors. The conversion layer can include several photoluminescent phosphors that absorb the light emitted by the LED and emit light with a longer wavelength. For example, for blue LEDs, the conversion layer can include a single photoluminescent phosphor emitting yellow light, or several photoluminescent phosphors that emit red and green light. For ultraviolet LEDs, the conversion layer can include photoluminescent phosphors emitting blue and yellow light, or photoluminescent phosphors emitting blue, green, and red light. Photoluminescent phosphors can be added that emit additional colors, in order to control the color coordinates and the rendering coefficient of the mixed light outgoing from the illuminator.

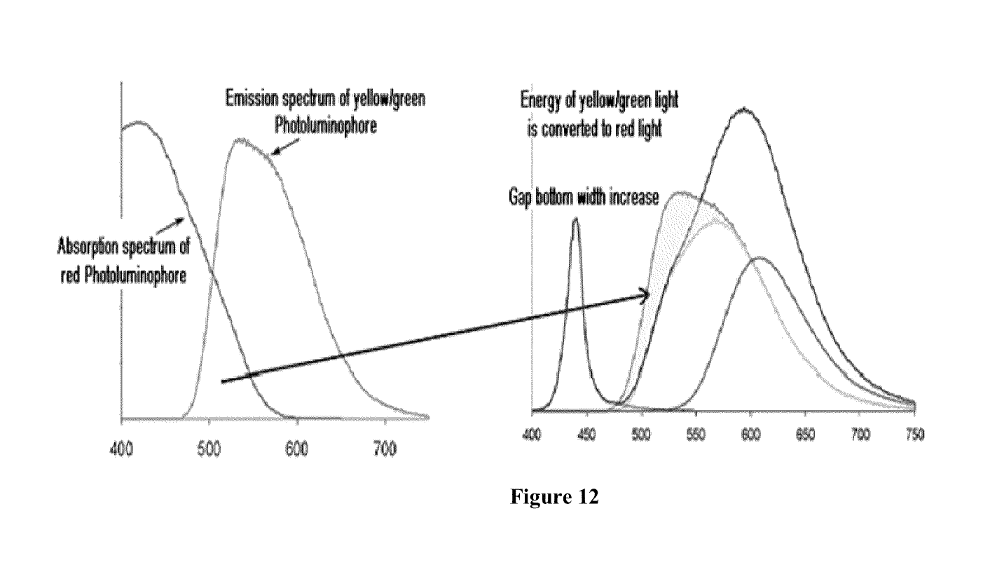

It is commonly believed that cascade interaction of phosphors caused by the overlap of a long-wave luminescent phosphor, e.g. a red one, and the emission spectrum of a short-wave luminescent phosphor, e.g. a green/yellow one, which eventually leads to the reabsorption of the energy of the short-wave (green/yellow) photons with the emission of long-wave (red) ones, impairs the efficiency of LEDs and reduces the white color rendering index (see, e.g., [7]). FIG. 12 illustrates the effect of photon reabsorption on the efficiency and white color rendering index. In this specific example the energy of green/yellow quanta is converted to red photons, and the bottom width of the gap between the emission bands of the green/yellow luminescent phosphor and the blue LED which excites the green/yellow luminescent phosphor increases. This deleteriously affects the color rendering index. It is therefore a common opinion that the interaction of the short-wave and the long-wave luminescent phosphors should be minimized.

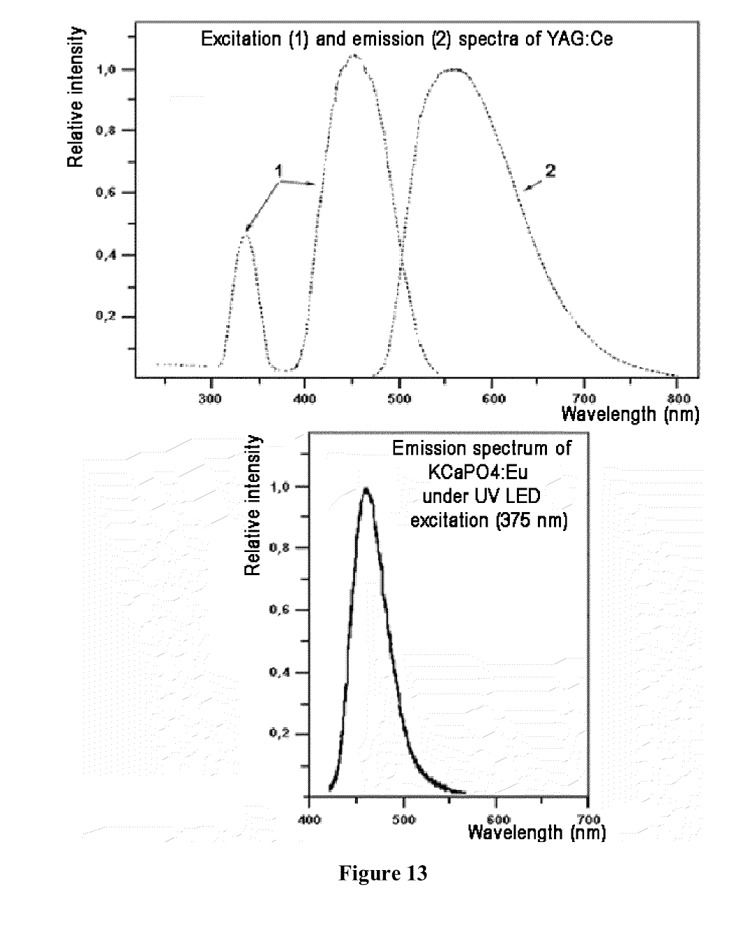

However, if the first conversion layer emission spectrum peak coincides with the second conversion layer excitation spectrum peak in the 450-470 nm range, the detrimental blue component is suppressed to the maximum extent in the 450-470 nm range of the second conversion layer emission spectrum and hence in the white light produced by the light source without compromising the white color rendering index. FIG. 13 shows the excitation and emission spectra of the YAG:Ce³⁺ luminescent phosphor which is most widely used in “white” LEDs and the emission spectrum of the new specially synthesized KCaPO₄:Eu²⁺ luminescent phosphor having an emission spectrum peak at 468 nm (emission spectrum halfwidth 80 nm) which is almost coincident with the long-wave excitation band peak of YAG:Ce³⁺.

The efficiency of the light source based on the cascade conversion of LED UV radiation to luminescent phosphor blue radiation followed by conversion to yellow radiation is only a little inferior to that for direct excitation of yellow luminescent phosphor by blue LED radiation. We carried out an experiment for UV-excited Ca₂(PO₄)Cl:Eu⁺² luminescent phosphor having a blue radiation spectrum peak at 450 nm and a halfwidth of 70 nm which excites the Y_{2.4}Gd_{0.54}Ce_{0.06}Al₅O₁₂ garnet luminescent phosphor having an excitation band at 450-0.05 nm to 475+0.05 nm.

Comparative data are summarized in Table 1 showing radiation intensity L produced as a result of the excitation of these luminescent phosphors and their combination by LED radiation with different wavelengths λ_{LED}, where L_{MgO} is the calibration intensity of LED radiation produced by irradiation of a MgO coated white surface.

TABLE 1

| | | | |
|---|---|---|---|
| Λ_{LED}, nm | 365 | 384 | 452 |
| L_{MgO}, r.u. | 13 | 17 | 72.3 |
| L_{blue}, r.u. | 67 | 17 | 646.7 |
| L_{yellow}, r.u. | 49 | 14 | 1087.7 |
| L_{LED+blue/yellow}, r.u. | 290 | 61 | 962 |
| Conversion Coefficient | 4.33 | 3.59 | 1.49 |

Conversion layers are most often made in the form of dispersion in a material that is optically transparent for the LED and luminescent phosphor radiation.

Transparent host materials can include polymer and inorganic materials. Polymer materials include (but are not limited to): acrylates, polycarbonate, fluoroacrylates, perfluoroacrylates, fluorophosphinate polymers, fluorosilicones, fluoropolyimides, polytetrafluoroethylene, fluorosilicones, sol-gels, epoxy resins, thermoplastics, heat-shrink plastics and silicones. Fluorine-containing polymers are especially useful in the ultraviolet ranges of wavelengths shorter than 400 nm and infrared wavelengths longer than 700 nm, due to their low absorption of light at these wavelength ranges. Typical inorganic materials include (but are not limited to): silicon dioxide, optical glasses, and chalcogenide glasses.

The photoluminescent phosphor of the conversion layer can conformally be applied as coating to the surface of the light reflector, e.g., by pulverizing, pasting, deposition or electrical endosmosis from the photoluminescent phosphor suspension in the liquid. One of the problems related to coating the reflector with photoluminescent phosphor is applying a uniform reproducible coating on the reflector, especially if the reflector has a non-planar surface, for example, cylindrical or hemispherical. Liquid suspensions are used to apply photoluminescent phosphor particles to the substrate when the pulverizing, pasting, deposition methods are applied. The uniformity of coating greatly depends on the viscosity of the suspension, particle concentration in suspension, and environmental factors, such as ambient temperature and humidity. Coating defects due to flows in the suspension before drying, and daily changes of the coating thickness are classified as ordinary problems.

In some cases, it is preferable to add the photoluminescent phosphor into the coating material, for example, transparent plastic, such as polycarbonate, PET, polypropylene, polyethylene, acrylic, shaped by extrusion. In this case, the conversion layer can be pre-manufactured in sheets, which are then heat molded into the desired shape. Before molding, the light-reflective coating made of, for example, aluminum or silver can be applied to one surface of the sheet by vacuum deposition.

The conversion layer of the conformally preformed reflective surface of a heat radiator can be attached to it, for example, with a silicone adhesive located between the conversion layer and the reflective surface of the heat radiator. In this case, the adhesive layer can be thin, thinner, for example, than the conversion layer, and can not maintain a large thermal resistance to the heart removal from the conversion layer.

In one of specific embodiments of the illuminator, a preformed sheet is used, which is pasted to a copper or brass cylindrical reflector with a thin layer of aluminum (0.5 μm), which is applied by vacuum thermal evaporation. An organic solvent is used to prepare the suspension of photoluminescent phosphor, surface-active agents (surfactants) and the polymer. The suspension can then be formed into a sheet by extrusion or mold casting or it can be poured on a flat substrate, for example, a glass one, followed by drying. The resulting sheet can be separated from the temporary substrate and attached to the reflector, using a solvent or cyanoacrylate adhesive. The reflector coated with the sheet is heated at 480° C., and the polymer matrix burns down, leaving the photoluminescent phosphor coating.

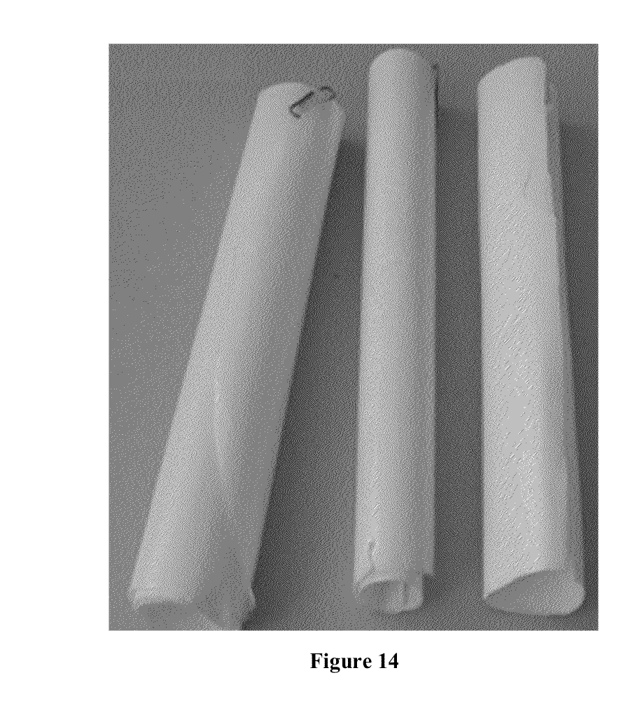

In a specific example, sheets of different thicknesses, as shown in FIG. 14, were formed by extrusion from the suspension of particles of an experimental photoluminescent phosphor based on yttrium-gadolinium-cerium aluminium garnet (Y,Gd,Ce)₃Al₅O₁₂ in a polycarbonate solution in methylene chloride. The conversion layer must be sufficiently thick to achieve the necessary color coordinate values of mixed white light outgoing from the illuminator aperture. The effective thickness is defined based on optical scattering processes in photoluminescent phosphors used and ranges, for example, between 5 and 500 μm, most often between 100 and 250 μm.

The sheet was secured to a cylindrical reflector by way of moistening the reflector with isopropanol and applying pressure to the sheet using a male die of a desired shape. The solvent softens the sheet and allows squeezing out air bubbles from under it to ensure full adhesion of the sheet to the reflector. The coated reflector was annealed in air at 480° C. to burn off the polymer, resulting in the cylindrical reflector covered with the photoluminescent phosphor. The reflector of a less complicated shape can be coated with a mixture of photoluminescent phosphor with transparent silicone binder; then, the mixture is annealed. In this case, the silicone binder is not removed by annealing. It must be borne in mind that photoluminescent phosphor, which converts blue light in the orange-red one, can degrade until complete uselessness after is has been heated to 480° C. in air. In this case, other polymers with a lower burning-off temperature must be used. In some embodiments, the burning-off temperature ranges from 260° C. to 540° C.

The surface of the conversion layer can be additionally coated with a transparent protective layer, which prevents the ingress of moisture and/or oxygen into the conversion layer, as some types of photoluminescent phosphors, e.g., sulfide one, are prone to damage from moisture attacks. The protective layer can be made of any transparent material which prevents moisture and/or oxygen from penetrating into the conversion layer, for example, made of inorganic materials, such as silicon dioxide, silicon nitride or aluminum oxide, and organic polymers or combinations of polymeric and inorganic layers. The preferable materials for the protective layer are silicon dioxide and silicon nitride.

The protective layer can also optically clear the boundary of a photoluminescent phosphor grain with the atmosphere and can reduce the reflection of the LED primary radiation and the secondary radiation of the photoluminescent phosphor on this boundary, reducing the absorption losses of the photoluminescent phosphor self-radiation in its grains, thereby increasing the efficiency of the illuminator.

The protective layer can also be applied by finishing surface treatment of photoluminescent phosphor grains, which, among other things, causes to form a nano-sized 50-100 nm film of zinc silicate on the surface of the grains, that clears the boundary of the photoluminescent phosphor grain.

The surface 10 of the converter 7 and the surface 6 of the reflector 5 can be shaped as axisymmetric figures (a sphere, ellipsoid, paraboloid, or otherwise) or surface symmetric figures (e.g., cylinder), truncated by a plane, which is, for example, parallel to the plane of the aperture 3 in the heat-removing base 2; in this case, the LEDs 1 are located near and along the conventional line of intersection of the said surface of the heat-removing base 2 with the said surface 10 of the converter 7.

The second converter can have a planar or convex shape and be in the form of a transparent plastic, glass or ceramic cap containing a photoluminescent material distributed over the cap volume or deposited in the form of a layer on the inner surface of said cap tightly closing the aperture and protecting the conversion layer from moisture and/or oxygen, wherein the inner volume of the light source can be filled with an inert atmosphere or evacuated.

The optimization of the converter surface 10 shape and of the location of the LED based on their radiation directivity diagram allows improving the color uniformity and angular distribution of the radiation coming out of the illuminator due to the incidence of the LED radiation to the converter surface 10 at different angles and redistribution of the reflected radiation inside the cavity of the converter 7 before its exit from the aperture.

As known from the specifications, say, for SemiLEDs chips of UV LEDs SL-V-U40AC or EZBright1000 family chips manufactured by CREE, the radiation directivity diagram of LED chips can have the Lambertian distribution (a light cone with an angle of obliquity of 90° to the surface of the LED chip) or be limited to a less cone with the angle α<90°, for example, when radiation is coupled out using a quantum-sized lattice structure formed on the surface of the LED chip.

In this case, the LED can be located on the heat-removing base in such a way that the axis of the LED radiation directivity diagram intersects the axis of symmetry of the reflector at an angle β≧90°−α/2.

However, a certain relatively small part of the LED primary radiation propagates directly outwardly the illuminator aperture; and to avoid the possible user's direct eye contact with the LED light, the heat-conducting base 2 can comprise a protrusion 13 that screens the direct yield of the primary radiation outwards the illuminator, bypassing the surface 10 of the first conversion layer 7. To ensure a more complete utilization of the LED primary radiation, the said protrusion 13 of the heat-conducting base 2 comprises an additional reflector—a flat mirror part 14 that directs the primary radiation falling on it towards the surface 10 of the first conversion layer 7.

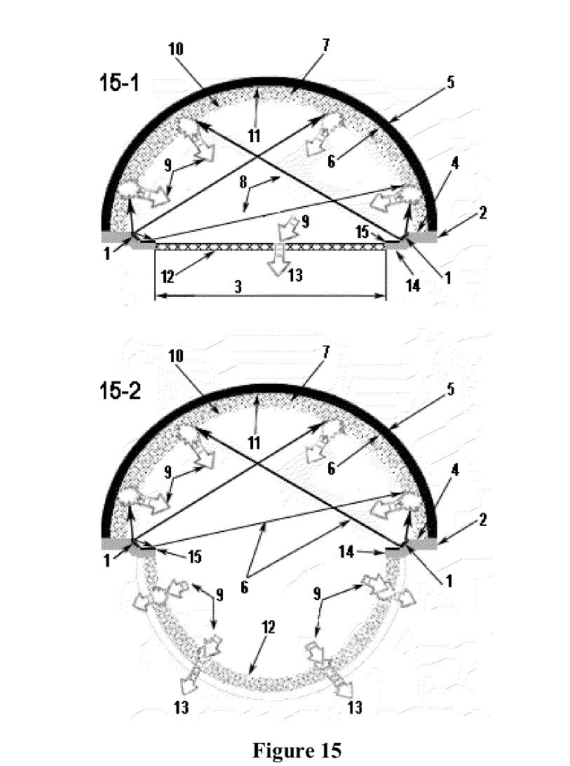

The embodiment of the illuminator comprising an additional reflector is schematically shown in FIG. 15 in more details for two variants: with flat (FIG. 14-1) and convex (FIG. 14-1) the second conversion layer 12.

The illuminator in this embodiment includes a protruding part 14 with a reflective coating 15 in addition to the elements shown in FIG. 11 and numbered in the same way as in FIG. 11.

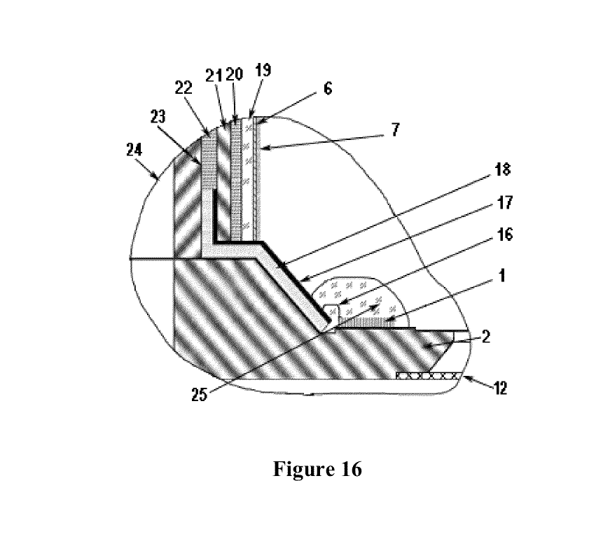

Another specific embodiment of the illuminator with an additional reflector is shown in details in FIG. 16, which shows an enlarged sectional view of the illuminator in the area of the base 2 with fixed LEDs 1 where the corresponding components are numbered in the same way as in FIG. 15 (not to scale).

The additional reflector is an inclined surface 17 (for example, a truncated conical surface put the base upwards in the case of an axisymmetrically shaped converter) located between the LED chips 1 and the first conversion layer 7, the reflection from which allows almost completely redirecting the portion of the LED chips 1 radiation falling onto it to the opposite side of the first conversion layer 7, which homogenizes the outgoing radiation of the illuminator.

To increase the reflection of light emitted by the LEDs and the conversion layer, the surface of the reflector in the heat radiator can be, among other things, polished or matted to homogenize the radiation and it can be covered with a coating with a high optical reflectance. The surface of the light reflector can also be made as a separate mirror distanced from the heat radiator, but maintaining a thermal contact with it through a thermally conductive layer. Examples of suitable coatings and materials for highly reflective coatings include silver; aluminum; dichroic coatings; aluminum combined with a dichroic coating to enhance the reflection coefficient of aluminum; and materials, such as titanium oxide and aluminum oxide, formed by the sol-gel method.

In this embodiment of the illuminator, the LED chips 1 are located on the base 2 so that the normal to the surface of the LED chip 1 is parallel (or makes a small angle) to the axis of symmetry of the reflector 6 made as a 0.15-0.2 μm thick reflecting aluminum or silver film applied by vacuum thermal deposition to the inner surface of a hemispherical glass cap 19, glued with an elastic heat-resistant compound 18 to the aluminum hemispherical cap 21, which acts as the second common electrode for the LED chips 1 that are connected to it in parallel by means of the conductors 16 and the polyimide ribbon 16 with the metallic coating 17. To enhance the light reflectivity, the metallic coating 17 on the polyimide ribbon is coated with a thin aluminum layer and serves as an additional reflector in addition to being the electric contact. With this layout of the LEDs, their primary radiation does not directly enter the eye of an observer.

The first electrode is the base 2, to which the LED chips 1 are soldered, and the heat radiator 24 that is in electrical and thermal contact with the base 2. Electrical power is supplied to the cap 21 by the central cylindrical output (not shown on FIG. 15) that is welded (or soldered) to the top of the cap 21 in axial alignment with the axis of symmetry of the reflector 6 and connected through an electrically insulated hole in the inner surface 23 of the heat radiator 24 to the supply driver located in the corresponding cavity made in the upper part of the heat radiator body (not shown).

The hemispherical cap 21 is bonded with the heat-resistant heat-conducting compound 22 to the inner surface 23 of the heat radiator 24 body.

The hemispherical cap 19 can also be made of heat-conducting ceramic. The hemispherical cap 21 can also be made of stainless steel, copper, brass, Kovar, or any similar material.

If the cap 21 is made of Kovar or another similar alloy that has relatively good thermal conductivity and a relatively low coefficient of thermal expansion, which is closest to the thermal expansion coefficient of the photoluminescent phosphors used in the first conversion layer 7, the design of the illuminator can be simplified and made cheaper and it can be made without the cap 19. To this end, the reflecting aluminum or silver film is applied by vacuum thermal deposition (or otherwise) to the inner surface of the Kovar cap 21, either directly or via an intermediate thin-film dielectric coating, followed by deposition of a photoluminescent phosphor layer using one of the previously described methods.

If the cap 21 is made of aluminum, stainless steel, copper, brass or similar materials with a relatively high coefficient of thermal expansion that is closest to the coefficient of thermal expansion of the first conversion layer 7 made of plastics with photoluminescent phosphor filler, the illuminator also can be made without cap 19. To this end, the inner surface of the cap 21 is polished and/or the reflecting aluminum or silver film is applied by vacuum thermal deposition, either directly or via an intermediate thin-film dielectric coating, followed by bonding a preformed plastic first conversion layer 7.

LED chips 1 and wire contacts 16 can be sealed with the optical compound 25 using the known technology applied in the manufacture of LED assemblies.

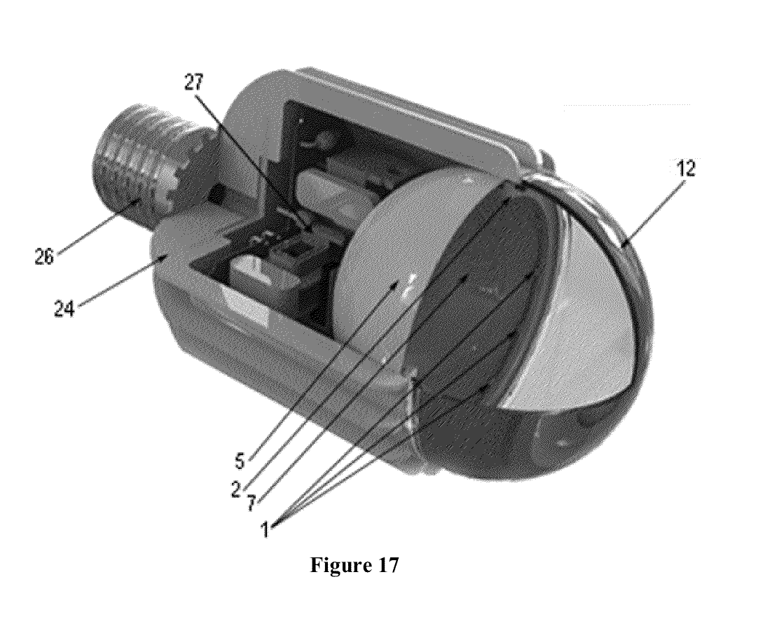

The heat radiator 24 can be made of any suitable material, such as copper or aluminum. The heat radiator can be ribbed to increase the heat transfer surface, for example, as shown in FIG. 17 where the source is shown in the form of a lamp with a standard base 26 and an integrated power unit 27.

Sheets similar to those shown in FIG. 14 we shaped to specimens of semi-cylindric photoluminescent converters based on polycarbonate composites: (1) with blue phosphor KCaPO₄:Eu²⁺ which acted as the first conversion layer in combination with Vikuiti™ ESR produced by 3M as a reflector, and (2) with yellow phosphor YAG:Ce³⁺ which acted as the second conversion layer. In accordance with this invention, a combination of these converters during first converter excitation by LED chips e.g. SL-V-U40AC produced by SemiLEDs with 375 nm wavelengths located around it, provides for efficient production of white light emission by the second converter excited by the radiation of the first converter, the light power being about 80-100 lm/W depending on conversion sheet thickness.

### REFERENCES

1. Yamada, K., Imai, Y. and Ishii K., “Optical Simulation of Light Source Devices Composed of Blue LEDs and YAG Phosphor,” J. Light & Vis. Env. 27(2), 70-74 (2003).
2. Narendran, N., Gu. Y., Freyssinier, J., Zhu, Y., “Extracting Phosphor-scattered Photons to Improve White LED Efficiency,” Phys. Stat. Sol. (a) 202(6), R60-R62 (2005).
3. Zhu Y., N. Narendran, and Y. Gu. “Investigation of the optical properties of YAG:Ce phosphor”. Sixth International Conference on Solid State Lighting. Proceedings of SPIE. 6337, 63370S (2006).
4. G. C. Brainard, J. P. Hanifin, J. M. Greeson et al. J. of Neuroscience 21(16), 6405 (2001)
5. Fabio Falchi, Pierantonio Cinzano, Christopher D. Elvidge, David M. Keith, Abraham Haim, “Limiting the impact of light pollution on human health, environment and stellar visibility”. Journal of Environmental Management, v.92, N10, pp. 2714-2722 (2011).
6. Hollan J. 2004. Metabolisminfluencing light: measurement by digital cameras. Poster at “Cancer and Rhythm”, Oct. 14-16, Graz, Austria, 2004. (http://amper.ped.muni.cz/noc/english/canc_rhythm/g_camer.pdf)
7. U.S. Pat. No. 7,250,715 B2.

1. Light source comprising a primary radiation source comprising one or multiple LEDs, a heat removing base with a surface on which said LEDs are installed, a primary radiation converter made in the form of a converting material layer converting primary radiation incident onto its surface from said LEDs into secondary radiation, a reflector with a surface reflecting incident radiation from said LEDs and primary radiation converter, with said reflector and said primary radiation converter being installed remotely from said primary radiation source and said primary radiation converter being installed between said primary radiation source and said reflector near said reflector surface, WHEREIN said light source comprises a second converter made in the form of a photoluminescent material layer converting radiation incident onto its surface from said primary radiation converter and said reflector into secondary radiation, further wherein said heat removing base has a radiation output aperture near which said LED and said primary radiation converter with said reflector are installed on said heat removing base, further wherein said primary radiation converter surface irradiated by said LED and said reflector surface have concave shapes with the concavity facing said primary radiation source and said output aperture, and said second converter has a planar or convex shape and is installed in said output aperture or at the other side of said output aperture, wherein the LED emission spectrum is in the excitation spectral region of the photoluminescent material of the primary radiation converter and the maximum of the emission spectrum of the primary radiation converter photoluminescent material is in the excitation spectral region of the photoluminescent material of the second converter.

2. Light source of claim 1 wherein the LED emission spectrum is within the spectral range equal to the halfwidth of the primary radiation converter material excitation spectrum at both sides of the primary radiation converter material excitation spectral maximum, and the maximum of the emission spectrum of the photoluminescent material of the first conversion layer is within the spectral range equal to the halfwidth of the second converter material excitation spectrum at both sides of the second converter material excitation spectral maximum.

3. Light source of claim 1 wherein second converter made from a photoluminescent material the excitation spectrum maximum of which is within the 450-470 nm range and the primary radiation converter is made from a material the excitation spectrum of which is in the violet or near ultraviolet region and the emission spectrum maximum of which is within the 450-470 nm range.

4. Light source of claim 1 wherein the photoluminescent material for the primary radiation converter is selected from a group comprising BaMgAl₁₀O₁₇:Eu²⁺; MgSrSiO₄:Eu²⁺; (Sr,Ba,Ca)₅(PO₄)₃Cl:Eu²⁺; (Sr₁₋ₓ₋ₐBa)J₃MgSi₂O₈:Euₐ (a=0.002-0.2,x=0.0-1.0); (Sr₁₋ₓ₋ₐSr)₂P₂O₇:Euₐ (a=0.002-0.2, x=0.0-1.0); (Sr₁₋ₓ₋ₐBaₓ)Al₁₄O₂₅:Euₐ (a=0.002-0.2, x=0.0-1.0); La₁₋ₐSi₃N₅:Ceₐ (a=0.002-0.5); (Y₁₋ₐ)₂SiO₅:Ceₐ (a=0.002-0.5); Ø(Ba₁₋ₓ₋ₐSrₓ)MgAl₁₀O₁₇:Euₐ (a=0.01-0.5, x-0.0-0.5), or mixtures thereof.

5. Light source of claim 2 wherein the photoluminescent material for the primary radiation converter has the general formula (Mg,Ca,Sr)₂(PO₄)Cl:Eu⁺² with (Mg: 0.05-0.2; Ca: 0.6-0.8; Sr:0.01-0.2) and Eu⁺² concentrations of 0.5% to 10%.

6. Light source of claim 2 wherein the photoluminescent material for the second converter is selected from a group comprising Y₂O₃:Eu³⁺; CeMgAl₁₁O₁₉:Tb³⁺; (Lanthanide)PO₄:Ce³⁺, Tb³⁺; GdMgB₅O₁₀:Ce³⁺, Tb³; YAG:Ce³⁺; YAG:Ho³⁺; YAG:Pr³⁺; (Ba_{1.65}Sr_{0.2}Mg_{0.1}Eu_{0.05})SiO₄; (Ba_{0.2}Sr_{1.54}Mg_{0.2}Eu_{0.06})SiO₄; (Ba,Ca,Zn,Eu)₂S₄(Ba 0.9-1.4; Ca 0.9-0.4; Zn 0.05-0.15; Eu 0.02-0.05); SrGa₂S₄; (Sr,Mg,Ca,Ba)(Ga,Al,In)₂S₄; SrS; SrGa₂S₄:Eu²⁺; SrGa₂S₄:Ce³⁺; SrS:Eu²⁺; (Sr_{1-a-b-c}Ba_{b}Ca_{c})₂Si₅N₈:Euₐ (a=0.002-0.2, b=0.0-1.0, c=0.0-1.0); (Ca₁₋ₓ₋ₐSrₓ)S:Euₐ, (a=0.0005-0.01, x=0.0-1.0); Ca₁₋ₐ, SiN₂:Euₐ (a=0.002-0.2); Ø(Ba₁₋ₓ₋ₐCaₓ)Si₇N₁₀:Euₐ (a=0.002-0.2, x=0.0-0.25); (Ba: 0.9-1.4; Ca:0.9-0.4; Zn:0.05-0.15; Eu:0.02-0.05), or mixtures thereof.

7. Light source of claim 3 wherein the photoluminescent material for the primary radiation converter is selected from a group comprising LiCaPO₄:Eu; NaCaPO₄:Eu; KCaPO₄:Eu; (Ba_{0.9}Ca_{0.9}Zn_{0.15}Eu_{0.05})₂S₄ and the photoluminescent material for the second converter is selected from a group comprising YAG:Ce³⁺; (Ba_{0.2}Sr_{1.54}Mg_{0.2}Eu_{0.06}) SiO₄; (Ba,Ca,Zn,Eu)₂S₄ (Ba 0.9-1.4; Ca 0.9-0.4; Zn 0.05-0.15; Eu 0.02-0.05), e.g. (Ba_{0.9}Ca_{0.9}Zn_{0.15}Eu_{0.05})₂S₄, or mixtures thereof.

8. Light source of claim 1, wherein the surfaces of the converter and the reflector are shaped as axisymmetric figures, truncated by a plane parallel to the plane of the hole in the heat-removing base, for example, as an ellipsoid of revolution, in particular, a sphere or a paraboloid, with the main axis perpendicular to the plane of the hole in the heat-removing base.

9. Light source of claim 1, wherein the surfaces of the converter and the reflector are shaped as surface symmetric figures, truncated by a plane parallel to the plane of the hole in the heat-removing base, for example, as a truncated cylinder with the axis of symmetry perpendicular to the plane of the hole in the heat-removing base.

10. Light source of claim 1, wherein the thermally conductive base comprises a protrusion that screens the direct yield of primary radiation into said hole to direction of the second converter.

11. Light source of claim 1, wherein the said reflector surface is the inner surface of a heat-removing radiator with a ribbed outer surface.

12. Light source of claim 2, wherein the said surfaces of the converter and reflector consist of a plurality of flat facets or segments.

13. Light source of claim 3, wherein the heat-removing base of the primary radiation source is integral with the light reflector.

14. Light source of claim 1, wherein the convex surface of the converter, opposite to its concave surface, which is irradiated by primary radiation, and the concave surface of the reflector are separated with an optically transparent medium.

15. Light source of claim 3, wherein the said protrusion of the heat-conducting base comprises a flat mirror part that directs the primary radiation falling on it to the opposite surface of the first converter.

16. Light source of claim 3, wherein the light-emitting diodes are secured on the heat-removing base so that the axis of the radiation directivity diagram of each light-emitting diode intersects the axis of symmetry of the reflector at an angle equal to or less than the difference between 90° and a half-width of the directivity diagram of each said light-emitting diode.

17. Light source of claim 3, wherein the light-emitting diodes are secured on the heat-removing base so that the axis of the radiation directivity diagram of each light-emitting diode is parallel to or makes a small angle with the axis of symmetry of the reflector; the heat conducting base between the surface of the converter and the light-emitting diodes comprises an inclined reflecting mirror part that directs primary radiation falling onto it to the opposite surface of the first converter.
